(19) United States
(12) Patent Application Publication
(10) Pub. No.: US 2020/0301754 A1
(43) Pub. Date: Sep. 24, 2020

(54) ELECTRONIC DEVICE AND METHOD FOR IMPLEMENTING PARTITIONING DURING THE EXECUTION OF SOFTWARE APPLICATIONS ON A PLATFORM COMPRISING A MULTI-CORE PROCESSOR, ASSOCIATED COMPUTER PROGRAM AND ELECTRONIC SYSTEM

(71) Applicant: THALES, Courbevoie (FR)

(72) Inventors: Marc FUMEY, Merignac (FR); Joel BOSSON, Merignac (FR); Tarik AEGERTER, Merignac (FR); Yves MEYER, Merignac (FR); Hubert LACQUIT, Merignac (FR)

(21) Appl. No.: 16/754,636

(22) PCT Filed: Oct. 10, 2018
(86) PCT No.: PCT/EP2018/077712

§ 371 Date: Apr. 8, 2020

(30) Foreign Application Priority Data
Oct. 11, 2017 (FR) 17 01054

(51) Int. Cl. G06F 9/52; G06F 9/50; G06F 9/30; G06F 9/38; G06F 9/48

(52) U.S. Cl. CPC G06F 9/522; G06F 9/5061; G06F 9/485; G06F 9/3009; G06F 9/3836; G06F 9/5027

(57) ABSTRACT

This method for implementing a partitioning during the execution of software applications on a platform comprising a multicore processor having several separate cores, is implemented by an electronic implementing device.

It comprises a step for switching between the execution of a current set of software application(s) on a plurality of cores and the execution of a subsequent set of software application(s) on the plurality of cores, carried out in a synchronous manner on said plurality of cores,
the step of synchronous multicore switching including one or more actions among a first group of actions consisting of:
   waiting, synchronized over the plurality of cores, for uninterruptible process(es) of the current set of software application(s) to finish running; and
   purging all memory resource(s) associated with the current set of software application(s).

### CROSS-REFERENCE TO RELATED APPLICATIONS

This application is a National Stage entry of International Application No. PCT/EP2018/077712, filed on Oct. 11, 2018, which claims priority to French Patent Application No. 17 01054, filed on Oct. 11, 2017. The disclosures of the priority applications are hereby incorporated in their entirety by reference.

### FIELD

The present invention relates to a method for implementing a partitioning during the execution of software applications on a platform comprising a multicore processor having several separate cores, the implementation method being carried out by an electronic implementing device.

The invention also relates to a non-transitory computer-readable medium including a computer program including software instructions which, when executed by a computer, implement such a method.

The invention also relates to an electronic device for implementing a partitioning during the execution of software applications on a platform comprising a multicore processor having several separate cores.

The invention also relates to an electronic system comprising a memory able to store software applications; a platform able to execute each software application, the platform comprising a multicore processor having several separate cores; and such an electronic device for implementing a partitioning during the execution of software applications on the platform.

The invention relates to the field of the qualification of embedded platforms including one or several multicore processors, in particular in the avionics field according to standard DO297.

### BACKGROUND

Using multicore processors creates substantial difficulty for the qualification of the platforms. Indeed, running several software applications at the same time on one multi-core processor creates risks of contention due to the sharing of common resources (bus, memory) with different cores, the behavior of the multi-core processor not being able to be controlled explicitly and predictively.

The term “contention” refers to any situation in which at least one activity carried out by at least one core of a multicore processor experiences delays in its performance due to the temporal parallelism allowed by said multicore processor.

The origin of the contentions is generally the use of shared resources of the processor or the operating system, also called OS, resulting in waits causing these delays. A contention then causes a delay in the execution of a software application hosted in a core.

A first example of contention is the internal bus (often called “interconnect”) connecting the cores to one another, as well as the cores to the peripherals, which does not always allow independent simultaneous transactions between cores or between the cores and the peripherals, such as certain integrated cache memories or the external memory.

Another example of contention is the use of common software modules of the OS installed on one of the cores and called by all of the cores, potentially at the same time. Simultaneous calls for such shared software modules lead to arbitration and the placement of some requests in standby in order to serialize the software processing operations on the core where the shared software module is installed.

Another example of contention is a temporary interruption of all of the cores on a particular event on one of the cores in order to manage a coherent status among all of the cores.

When the processor is further a processor purchased from a supplier, or a COTS (Commercial Off-The-Shelf) processor, it is generally impossible to access the design details of the internal members of such a multicore processor, and it is therefore very difficult, if not impossible, to guarantee a deterministic behavior of the processor.

According to a first known type of software architecture for a platform with a multi-core processor, also called SMP (Symmetrical Multi-Processing) architecture, a single operating system decides at each moment which software processing is executed on which core.

According to a second known type of software architecture for a platform with a multi-core processor, also called AMP (Asymmetrical Multi-Processing) architecture, each core sequences the execution of a set of software applications, independently from one core to the next, with one operating system per core.

However, such architectures are not intrinsically deterministic enough to obtain the qualification of platforms with multicore processors, in particular in the avionics field according to standard DO297.

### SUMMARY

The aim of the invention is then to propose a method and a device for implementing a partitioning during the execution of software applications on a platform with multicore processors, which make it possible to control the impact of contention(s) during the execution of said software applications and then to facilitate the qualification of the platform.

To that end, the invention relates to a method for implementing a partitioning during the execution of software applications on a platform comprising a multicore processor having several separate cores, the implementation method being carried out by an electronic implementing device and comprising the following step:
switching between the execution of a current set of software application(s) on a plurality of cores and the execution of a subsequent set of software application(s) on the plurality of cores, carried out in a synchronous manner on said plurality of cores,

the step of synchronous multicore switching including one or more actions among a first group of actions consisting of:
waiting, synchronized over the plurality of cores, for uninterruptible process(es) of the current set of software application(s) to finish running; and
purging all memory resource(s) associated with the current set of software application(s).

With the implementation method according to the invention, the cores are synchronized and the running of the software applications is segmented into time clusters, the multicore synchronous switching making it possible to perform a robust partitioning between two successive time clusters, in particular within the meaning of standard DO297.

According to other advantageous aspects of the invention, the implementation method comprises one or more of the following features, considered alone or according to all technically possible combinations:
the step of synchronous multicore switching is performed synchronously over all of the cores of the processor;
the step of synchronous multicore switching includes all of the actions of the first group of actions;
the step of synchronous multicore switching further includes one or more actions among a second group of actions consisting of:
   resetting input(s)-output(s) associated with the subsequent set of software application(s);
   saving the context of the current set of software application(s); and
   restoring the context of the subsequent set of software application(s);
the method further comprises a step of switching between the running of a first software application and the running of a second software application on a same core, during the running of a given set of software application(s);
the step of switching on a same core includes one or more actions among the group consisting of:
   waiting for uninterruptible process(es) of the first software application to finish running;
   purging memory resource(s) of the core, including the corresponding private cache(s);
   saving the context of the first software application; and
   restoring the context of the second software application;
the platform hosts a single operating system for all of the cores and/or an operating system for each core.

The invention also relates to a non-transitory computer-readable medium including a computer program including software instructions which, when executed by a computer, carry out an implementation method as defined above.

The invention also relates to an electronic device for implementing a partitioning during the execution of software applications on a platform comprising a multicore processor having several separate cores, the device comprising:
a switching module configured to switch between the execution of a current set of software application(s) on a plurality of cores and the execution of a subsequent set of software application(s) on the plurality of cores, in a synchronous manner on said plurality of cores,

the switching module being configured to perform one or several actions among a first group of actions consisting of:
waiting, synchronized over the plurality of cores, for uninterruptible process(es) of the current set of software application(s) to finish running; and
purging all memory resource(s) associated with the current set of software application(s).

The invention also relates to an electronic system comprising:
a memory able to store software applications;
a platform able to execute each software application, the platform comprising a multicore processor having several separate cores; and
an electronic device for implementing a partitioning during the running of software applications on the platform, the electronic implementation device being as defined above.

### BRIEF DESCRIPTION OF DRAWINGS

These features and advantages of the invention will appear more clearly upon reading the following description, provided solely as a non-limiting example, and done in reference to the appended drawings, in which:

FIG. 1 is a schematic illustration of an electronic system according to the invention, comprising a memory able to store software applications; a platform able to execute each software application, the platform including resources, in particular at least one multicore processor having several separate cores, and hosting an operating system; and an electronic device for implementing a partitioning during the execution of software applications on the platform;

FIG. 2 is a flowchart of a method, according to the invention, for implementing a partitioning during the execution of software applications on the platform, the method being implemented by the implementing device of FIG. 1;

FIG. 3 is a schematic illustration of the implementation of partitioning with a quad-core processor for a general architecture;

FIG. 4 is a view similar to that of FIG. 3 for an architecture of the symmetrical multiprocessing (SMP) type;

FIG. 5 is a view similar to that of FIG. 3 for an architecture of the asymmetrical multiprocessing (AMP) type; and

FIG. 6 is a view similar to that of FIG. 3 with a dual-core processor for a mixed architecture in terms of processing.

### DETAILED DESCRIPTION

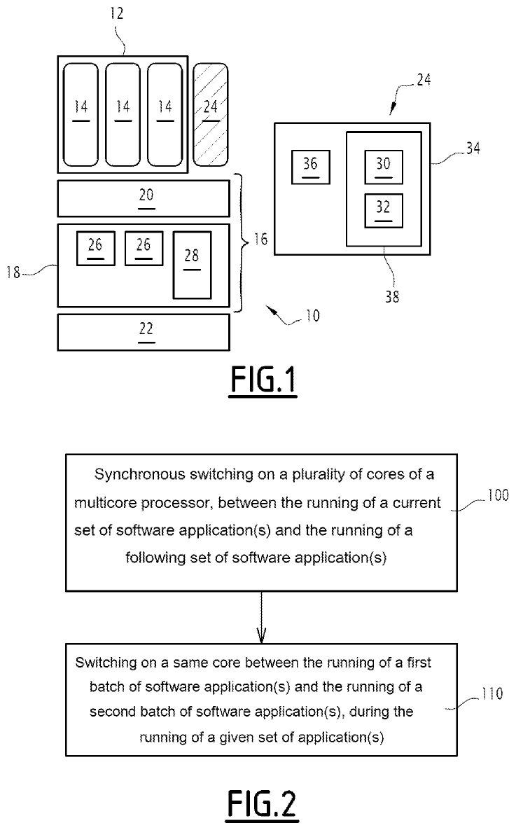

In FIG. 1, an electronic system 10, in particular an avionics electronic system intended to be on board an aircraft, comprises a memory 12 able to store software applications 14; a platform 16 able to execute each software application 14, the platform 16 including resources 18 and hosting at least one operating system 20, the platform 16 being connected to other electronic systems 22 of the aircraft, such as other electronic avionics systems of the aircraft.

The electronic system 10 further comprises, according to the invention, an electronic device 24 for implementing a partitioning during the running of software applications 14 on the platform 16.

In FIG. 1, to simplify the drawing, the memory 12 has been shown outside the rectangle symbolizing the resources 18, in order to provide a distinct illustration of the software layer corresponding to the software applications 14, as well as the implementing device 24, if applicable. Nevertheless, one skilled in the art will of course understand that the memory 12 is included in the resources 18 of the platform 16.

The aircraft is preferably an airplane. Alternatively, the aircraft is a helicopter, or a drone piloted remotely by a pilot.

In the example of FIG. 1, the memory 12 is able to store three separate software applications 14, and the electronic implementing device 24 is then configured to implement the partitioning during the running of these software applications 14.

Each software application 14 is intended to be executed by the platform 16 and then designed to emit one or several calls to the operating system 20 hosted by the platform 16 and is also configured to use resources 18 of the platform 16.

When the electronic system 10 is an electronic avionics system embedded in the aircraft, each software application 14 is also called avionics function. The software applications 14 for example perform different functions to carry out a flight, and are for example installed on different platforms 16 and use the resources 18 of said platforms 16.

Such functions being critical, for example the braking system or the flight management system, the running of each software application 14 must be separated robustly from the running of the other software applications 14, throughout their entire running duration.

The platform 16 is in particular intended to be embedded in the aircraft. The platform 16 is for example an information processing unit made up of one or several memories associated with one or several processors.

The invention is applicable to different types of software architectures, in particular to a so-called symmetrical multi-processing (SMP) architecture, or to an asymmetrical multiprocessing (AMP) architecture.

An SMP architecture more specifically refers to a software architecture where the operating system 20 decides at each moment which process is run on which processor core.

In the case of the SMP architecture, the platform 16 for example comprises a single operating system 20, and a single partition is active at a given moment in time. For the SMP architecture, the platform 16 then hosts a single operating system 20 for all of the cores.

In the case of the SMP architecture, the installation of software applications 14 is for example done in parallel on several cores.

An AMP architecture more specifically refers to a software architecture where each core sequences a set of software applications independently of the other cores.

In the case of the AMP architecture, the platform 16 for example comprises a plurality of operating systems 20, while hosting an operating system 20 for each core, then making it possible to activate different partitions at a given moment in time.

In the case of the AMP architecture, the installation of software applications 14 is for example done sequentially on a single core independently of the other cores.

The resources 18 of the platform 16 are physical or logic elements capable of being provided to the software application(s) 14.

The resources 18 are for example divided into the following categories:
resources of the data processing type. Such resources for example include one or several multicore processors each having several separate cores;
resources of the mass memory type;
resources of the input and output type;
resources specific to the avionics network. Such resources are for example the communication routers of an ARINC664 network; and
resources of the graphic type, that is to say, resources allowing a display. A monitor is one example of such resources.

In the example of FIG. 1, in terms of resources of the data processing type, the platform 16 comprises several multicore processors 26 each having several separate cores, and more specifically two multicore processors 26. In a variant, the platform 16 comprises a single multicore processor 26 having several separate cores.

In the example of FIG. 1, in terms of resources of the mass memory type, the platform 16 comprises a mass memory 28.

The operating system 20 is for example an operating system according to the ARINC 653 standard, or a POSIX operating system, or a hypervisor, or middleware.

One skilled in the art will then understand that the operating system 20 is to be understood broadly, and is more generally a set of at least one system software program, designed to offer services of different types to each application 14.

The electronic implementing device 24 is configured to implement the desired partitioning during the running of the software applications 14 on the platform 16 comprising at least one multicore processor 26.

The electronic implementing device 24 comprises a first switching module 30 configured to switch between the running of a current set of software application(s) 14 on a plurality of cores of the corresponding processor 26 and the running of a subsequent set of software application(s) 14 on the plurality of cores of the corresponding processor 26, in a synchronous manner on said plurality of cores.

As an optional addition, the electronic implementing device 24 comprises a second switching module 32 configured to switch between the running of a first software application and the running of a second software application on a same core, during the running of a given set of software application(s) 14.

As shown in crosshatched form in FIG. 1, the implementing device 24 is preferably able to be run directly by the platform 16 and then to use its resources 18. The implementing device 24 is then preferably further hosted by the operating system 20.

In a variant, also shown in FIG. 1, the implementing device 24 is separate from the platform 16, and comprises an information processing unit 34 for example made up of a processor 36 associated with a memory 38.

In the example of FIG. 1, whether the implementing device 24 is separate from the platform 16 or hosted and executed by the platform 16, the first switching module 30, and as an optional addition the second switching module 32, are each made in the form of software, or a software component, executable by a processor, such as the processor 32 when the implementing device 24 is separate from the platform 16. The memory 34 of the implementing device 24 is then able to store first switching software configured to switch, synchronously on said plurality of cores of the corresponding processor 26, between the running of the current set of software application(s) 14 and the running of the subsequent set of software application(s) 14. As an optional addition, the memory 34 of the implementing device 24 is then able to store second switching software configured to switch, on a same core, between the running of the first software application and the running of the second software application, during the running of said current set of software application(s) 14.

In a variant that is not shown, the first switching module 30, and as an optional addition the second switching module 32, are each made in the form of a programmable logic component, such as an FPGA (Field Programmable Gate Array), or in the form of a dedicated integrated circuit, such as an ASIC (Application-Specific Integrated Circuit).

When the implementing device 24 is made in the form of one or several software programs, i.e., in the form of a computer program, it is further able to be stored on a medium, not shown, readable by computer. The computer-readable medium is for example a medium suitable for storing electronic instructions and able to be coupled with a bus of a computer system. As an example, the readable medium is a floppy disk, an optical disc, a CD-ROM, a magnetic-optical disc, a ROM memory, a RAM memory, any type of non-volatile memory (for example, EPROM, EEPROM, FLASH, NVRAM), a magnetic card or an optical card. A computer program including software instructions is then stored on the readable medium.

The first switching module 30 is then configured to perform one or several multicore synchronous switches 40 on multiple cores of a corresponding multicore processor 26.

To perform a multicore synchronous switch 40, the first switching module 30 is configured to perform, synchronously on the plurality of cores of a corresponding multicore processor 26, one or several actions among a first group of actions consisting of: waiting, synchronized over the plurality of cores, for uninterruptible process(es) of the current set of software application(s) to finish running; and purging all memory resource(s) associated with the current set of software application(s).

Memory resources of the plurality of cores refer in general to any memory space of a core, whether it involves a cache, a register or a larger memory space.

Purging a memory resource is the reset of this memory resource.

The first switching module 30 is preferably configured to perform each synchronous multicore switching 40 over all of the cores of the corresponding multicore processor 26. If applicable, the first switching module 30 is configured to perform the aforementioned action(s) of the first group of actions synchronously over all of the cores of the corresponding multicore processor 26.

One skilled in the art will understand that multicore synchronous switching 40 is triggered at a determined moment by the platform 16, typically by configuration, and for all of the affected cores, this triggering being, in light of the aforementioned synchronism, done at the same time for said plurality of cores, and then being simultaneous or quasi-simultaneous. The notion of synchronism depends on the software applications 14; a duration dedicated to the synchronous switching, such as typically several hundreds of microseconds, is for example defined as a duration during which no application activity is performed and the switching activities on the various cores are partially sequential. At the end of switching, the application activity is relaunched simultaneously on all of the cores.

The first switching module 30 is preferably configured to perform all of the actions of the first group of actions, on the plurality of cores of the corresponding multicore processor 26 or preferably on all of the cores of the corresponding multicore processor 26.

In addition, the first switching module 30 is configured to further perform one or several actions among a second group of actions consisting of: resetting input(s)-output(s) associated with the subsequent set of software application(s); saving the context of the current set of software application(s); and restoring the context of the subsequent set of software application(s).

When the first switching module 30 is configured to perform both the actions of the first group of actions and those of the second group of actions, it is preferably configured to perform them in the following order:
waiting, synchronized over the plurality of cores, for uninterruptible process(es) of the current set of software application(s) 14 to finish running;
purging all memory resource(s) associated with the current set of software application(s) 14;
saving the context of the current set of software application(s) 14;
resetting input(s)-output(s) associated with the subsequent set of software application(s) 14;

and
restoring the context of the subsequent set of software application(s) 14.

As an optional addition, the second switching module 32 is, during the running of a given set of software application(s) 14, configured to switch between the running of a first software application and the running of a second software application on a same core. The second switching module 32 is then configured to perform an internal switching 42 to a respective core of the corresponding processor 26.

To perform an internal switching 42 to a respective core, the second switching module 32 is configured to perform one or several actions among the group consisting of: waiting for uninterruptible process(es) of the first software application to finish running; saving the context of the first software application; purging memory resource(s) of the core, including the corresponding private cache(s); and restoring the context of the second software application.

The second switching module 32 is preferably configured to perform all of the actions of the aforementioned group of actions on the respective core of the corresponding multicore processor 26.

The operation of the implementing device 24 according to the invention will now be explained using FIG. 2 showing a flowchart of the method, according to the invention, for implementing a partitioning during the running of software applications 14 on the platform 16, the method being carried out by the electronic implementing device 24.

During a step 100, the implementing device 24 implements, via its first switching module 32, a synchronous multicore switching 40.

This synchronous multicore switching step 100 includes one or several actions among the first group of actions consisting of: waiting, synchronized over the plurality of cores, for uninterruptible process(es) of the current set of software application(s) to finish running; and purging all memory resource(s) associated with the current set of software application(s).

This step of synchronous multicore switching 100 is performed synchronously over the affected plurality of cores of the corresponding multicore processor 26.

This step of synchronous multicore switching 100 is preferably performed synchronously over all of cores of the corresponding multicore processor 26. The aforementioned action(s) of the first group of actions are then performed synchronously over all of the cores of the corresponding multicore processor 26.

Each synchronous multicore switching step 100 is triggered at a determined moment by the platform 16, typically by configuration, and for all of the affected cores.

Each synchronous multicore switching step 100 preferably includes all of the actions of the first group of actions, the latter then being performed on the plurality of cores of the corresponding multicore processor 26 or preferably on all of the cores of the corresponding multicore processor 26.

In addition, each synchronous multicore switching step 100 further includes one or several actions among the second group of actions consisting of: resetting input(s)-output(s) associated with the subsequent set of software application(s); saving the context of the current set of software application(s); and restoring the context of the subsequent set of software application(s).

As an optional addition, during a next step 110, the implementing device 24 carries out, via its second switching module 32, one or several internal switches 42 to a respective core of the corresponding processor 26.

Each switching step on a same core 110 between the running of a first software application and the running of a second software application on a same core, during the running of a given set of software application(s), includes one or several actions from the group consisting of: waiting for uninterruptible process(es) of the first software application to finish running; saving the context of the first software application; purging memory resource(s) of the core, including the corresponding private cache(s); and restoring the context of the second software application.

Each switching step on a same core 110 preferably includes all of the actions of the aforementioned group of actions on the respective core of the corresponding multicore processor 26.

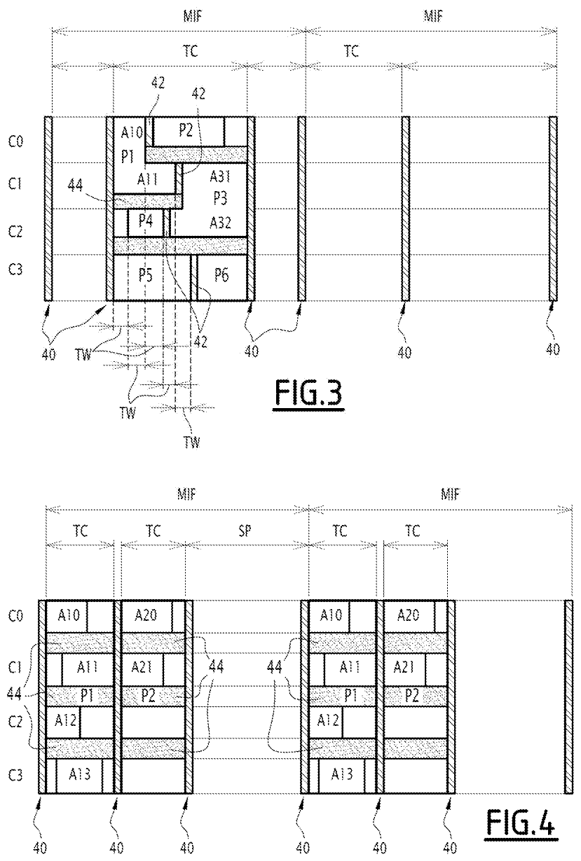

Thus, the implementing device 24 and the implementing method according to the invention make it possible, via one or several successive synchronous multicore switches 40 and as shown in the example of FIG. 3 with a quad-core processor for a general architecture, to synchronize the cores of the corresponding multicore processor 26 and to segment the running time of the multicore processor 26 into time clusters TC, a synchronous multicore switch 40 being placed between two successive time clusters TC.

This segmentation into time clusters TC with synchronous multicore switches 40 then makes it possible to obtain more robust partitioning, in particular absolute time partitioning, during the running of software applications 14 on the platform 16.

Absolute time partitioning refers to an implementation allowing isolation between time clusters TC irrespective of the core of the corresponding multicore processor 26.

Absolute spatial partitioning refers to an implementation allowing isolation, in terms of resource allocations, in particular of memory resources, between all of the installed partitions irrespective of the core of the corresponding multicore processor 26.

A partition refers to a temporal and spatial area allocated to a software application 14 or to a group of software applications 14 on one or several cores.

In other words, each synchronous multicore switch 40 then makes it possible to provide complete cleaning of the entire multicore context, that is to say, to eliminate any trace of execution related to the previous time cluster for the entire multicore context, that is to say, to eliminate any trace of running related to the previous time cluster for the cores in question, and then to offer absolute partitioning, that is to say, not involving any constraint introducing dependencies between software applications 14.

In FIGS. 3 to 6, each partition is designated by a reference Pi, where i is an integer index representing the number of the corresponding partition. Each core of the multicore processor of each of these examples is designated by a reference Cj, where j is an integer index between 0 and 3 for the examples of FIGS. 3 to 5 with a quad-core processor, respectively between 0 and 1 for the example of FIG. 6 with a dual-core processor, j representing the number of the corresponding core. If applicable, Aij designates a part of the software application 14 installed in a partition with index i and on a core with index j.

In the example of FIGS. 3 to 6, each time cluster TC between two synchronous multicore switches 40 includes one or several time windows TW. Each time window TW designates a time range delimited by two successive events making it possible to process a partition end or an internal switch 42 to a core. This notion is useful for the operating system 20 responsible for processing all of these events potentially in a centralized manner, but does not prejudge the impact of such an event on a core that is not affected by this event.

In FIGS. 3 to 6, the notation MIF (Minor Frame) represents the real periodic time base allowing the synchronization of operating systems 20, in particular on which the operating systems 20 of the various cores are synchronized in the case of the AMP architecture.

One skilled in the art will also observe that the multicore processor further makes it possible to offer a partitioning between cores 44, also called inter-core partitioning, shown by the zones filled with dots in FIGS. 3 to 6, between a partition or application run on one core and a partition or application run on another core.

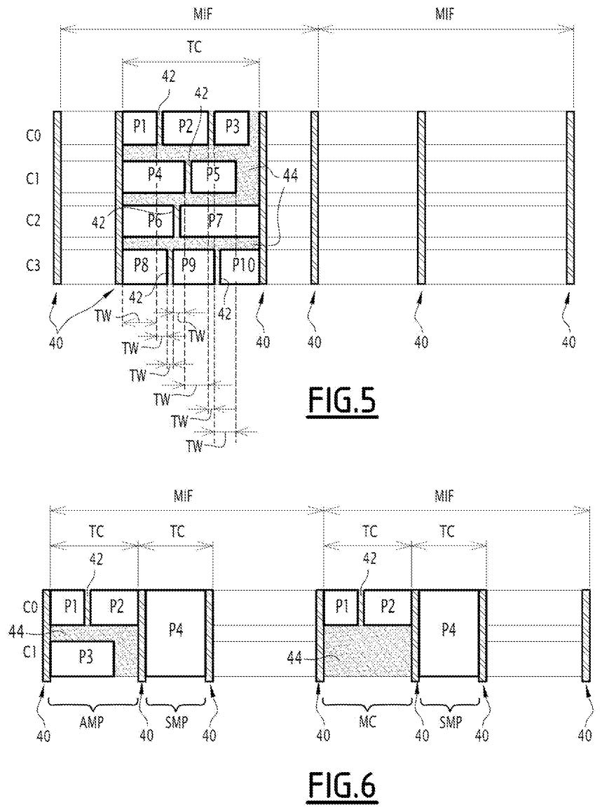

FIG. 4 is then an exemplary implementation of partitioning with a quad-core processor for an architecture of the SMP type, FIG. 5 being a similar exemplary implementation of partitioning with the quad-core processor for an architecture of the AMP type. Lastly, FIG. 6 is an exemplary implementation of partitioning with a dual-core processor for an architecture of the mixed AMP/SMP type, furthermore with an operation in mono-core mode only on core CO during the time cluster identified by the brace marked MC (for mono-core).

Similarly to the example of FIG. 3, one skilled in the art will observe, in the examples of FIGS. 4 to 6, that the different synchronous multicore switches 40 offer absolute time partitioning between time clusters TC. In the example of FIG. 4, time cluster SP (Spare) corresponds to a free time cluster, for which no partition or application is run.

One skilled in the art will understand that the various time clusters TC, as defined above, in particular the determination of the moments at which the successive synchronous multicore switches 40 must be done, are defined during a preliminary design phase or during a mission preparation phase, prior to the implementation of the inventive method.

When the electronic system 10 is an avionics electronic system embedded in the aircraft, this definition of the time clusters TC is further preferably done prior to flight of the aircraft, the implementing method according to the invention preferably being carried out during the flight of the aircraft.

One skilled in the art will also note that it is further possible to install several software applications 14 in separate partitions inside a same time cluster TC using different methods. According to a first method, two partitions are installed in parallel on separate cores, and benefit from partitioning between cores, also called inter-core partitioning. According to a second method, two partitions are installed sequentially on a same core or a set of cores, and in this case benefit from partitioning through one or several internal switches 42, core by core, also called intra-core partitioning. A third method corresponds to a mixture of the first and second methods with inter-core and intra-core partitioning.

Furthermore, the internal switching 42 to a core cannot eliminate all causes of dependency between the preceding and subsequent software applications 14 from a time perspective (contention resulting from a chain between preceding software application, other software application on another core, subsequent software application). This results in the potential presence of jitter on the running time of a software application 14, the jitter depending on the activity of the other software applications 14. There is then ultimately no difference, with respect to the isolation of the software applications 14 within a same time cluster TC, between two applications installed on a same core and separated by an internal switch 42 and two applications installed on two different cores.

As an optional addition and in order to further improve the operating safety of the platform 16, the implementing device 24, or another monitoring device, is configured to monitor the running times within a time cluster TC when several independent software applications 14 are installed. The consequence of exceeding a running time being able to threaten the operating safety, corrective actions, such as resetting the affected software applications 14 or stopping the least critical software applications 14, are provided after this monitoring is triggered. Such corrective actions seek to restore a safer context following such events and to discharge the corresponding multicore processor 26, in order to regain a situation free of exceptional contentions.

One can thus see that the method and the implementing device 24 according to the invention make it possible, due to the partitioning resulting in particular from each synchronous multicore switching 40, to control the impact of contention(s) during the running of software applications 14 and to then facilitate the qualification of the platform 16.

1. A method for implementing a partitioning during the execution of software applications on a platform comprising a multicore processor having several separate cores,
the implementing method being implemented by an electronic implementing device and comprising the following step:
switching between the execution of a current set of software application(s) on a plurality of cores and the execution of a subsequent set of software application(s) on the plurality of cores, carried out in a synchronous manner on said plurality of cores,
the step of synchronous multicore switching including one or more actions among a first group of actions consisting of:
waiting, synchronized over the plurality of cores, for uninterruptible process(es) of the current set of software application(s) to finish running;
purging all memory resource(s) associated with the current set of software application(s).

2. The method according to claim 1, wherein the step of synchronous multicore switching is performed synchronously over all of the cores of the processor.

3. The method according to claim 1, wherein the step of synchronous multicore switching includes all of the actions of the first group of actions.

4. The method according to claim 1, wherein the step of synchronous multicore switching further includes one or more actions among a second group of actions consisting of:
resetting input(s)-output(s) associated with the subsequent set of software application(s);
saving the context of the current set of software application(s); and
restoring the context of the subsequent set of software application(s).

5. The method according to claim 1, wherein the method further comprises the following step:
switching between the running of a first software application and the running of a second software application on a same core, during the running of a given set of software application(s).

6. The method according to claim 5, wherein the step of switching on a same core includes one or more actions among the group consisting of:
waiting for uninterruptible process(es) of the first software application to finish running;
purging memory resource(s) of the core, including the corresponding private cache(s);
saving the context of the first software application; and
restoring the context of the second software application.

7. The method according to claim 1, wherein the platform hosts a single operating system for all of the cores or an operating system for each core.

8. A non-transitory computer-readable medium including a computer program comprising software instructions which, when executed by a computer, carry out a method according to claim 1.

9. An electronic device for implementing a partitioning during the execution of software applications on a platform comprising a multicore processor having several separate cores, the device comprising:
a switching module configured to switch between the execution of a current set of software application(s) on a plurality of cores and the execution of a subsequent set of software application(s) on the plurality of cores, in a synchronous manner on said plurality of cores,
the switching module being configured to perform one or several actions among a first group of actions consisting of:
waiting, synchronized over the plurality of cores, for uninterruptible process(es) of the current set of software application(s) to finish running; and
purging all memory resource(s) associated with the current set of software application(s).

10. An electronic system, comprising:
a memory able to store avionics software applications;
a platform able to execute each software application, the platform comprising a multicore processor having several separate cores; and
an electronic device for implementing a partitioning during the running of software applications on the platform, the electronic implementation device being according to claim 9.
